(19) United States
(12) Patent Application Publication
(10) Pub. No.: US 2005/0046133 A1
(43) Pub. Date: Mar. 3, 2005

(54) Apparatus for the disposition and transportation of items

(75) Inventors: Gregor vom Braucke, Bielefeld (DE); Marcus vom Braucke, Vlotho (DE)

Correspondence Address: BURNS DOANE SWECKER & MATHIS L L P, POST OFFICE BOX 1404, ALEXANDRIA, VA, 22313-1404, US

(73) Assignee: BIELEFELDER KUCHENMASCHINEN, Bielefeld (DE)

(21) Appl. No.: 10/924,829

(22) Filed: Aug. 25, 2004

(30) Foreign Application Priority Data
Sep. 3, 2003 (DE) 203 13 623.3

(51) Int. Cl. B62B 3/00

(52) U.S. Cl. 280/47.35

(57) ABSTRACT

A cart onto which items can be deposited and transported includes a plurality of legs, and a plurality of vertically spaced shelves supported by the legs. Each leg is formed by a plurality of interconnected leg pieces. Each leg includes a plurality of vertically spaced support arms projecting laterally. Each support arm constitutes part of a nodal piece which is inserted between adjacent leg pieces to interconnect such leg pieces. A plurality of vertically spaced shelves are supported by the legs. Each shelf has its underside seated on the free ends of the support arms. Each shelf extends outwardly past those free ends, and the outer peripheral edge of each shelf is recessed to accommodate the leg pieces.

This application claims priority under 35 U.S.C. §§ 119 and/or 365 to Patent Application Serial No. 203 13 623.3 filed in Germany on Sep. 3, 2003, the entire content of which is hereby incorporated by reference.

### BACKGROUND OF THE INVENTION

The invention relates to an apparatus, such as a cart, for the deposition and transportation of items comprised of at least two shelf boards that are arranged at a vertical distance relative to each other, in particular as end table or storage for files, tools or assembly components, and at least the top shelf board of the two boards is arranged at the top end of three or four legs.

Apparatuses of this kind with at least two levels having shelf boards arranged at a distance from each other are known from many embodied examples, for example as file frames that are suitable in particular for the deposition of files. These types of apparatuses can also be used as workshop trays for tools and accessories, as end tables or serving tables for dishes etc. Said apparatuses feature two shelf boards that are arranged at a vertical distance relative to each other and are supported by continuous legs, with the shelf boards being fixed in place relative to each other by way of aligned legs. It is also possible to envision rollers on the feet of the legs of the bottom shelf board that can be used to move the apparatus around. With regard to this method it is disadvantageous that the shelf boards, which are arranged one above the other, are either fixedly connected to each other or that the connection is easily detachable causing the mobility of the apparatus to be rendered questionable, in particular when crossing thresholds or steps such as are encountered in a porch or garden areas.

Resulting from the above is the underlying technical problem that is the object of the present invention which is to provide, while overcoming the disadvantages, an apparatus of this class that is to be mobile, economical to manufacture, easy to handle and safe to use.

### SUMMARY OF THE INVENTION

The object is achieved by an apparatus for the deposition and transportation of items which comprises at least three and no more than four legs, and a plurality of vertically spaced shelves supported by the legs. The shelves include a topmost shelf supported at top ends of the legs. An outer edge of the topmost shelf includes recesses for accommodating the top ends of respective legs. Each leg is comprised of a plurality of aligned leg pieces.

Preferably, the outer edges of all shelves are provided with the recesses, each leg includes a plurality of vertically spaced, laterally extending support arms having a free end on which the underside of a respective shelf rests. The shelf extends outwardly past the free ends such that the recesses formed in the edges of the shelves accommodate the leg pieces.

Preferably, each support arm comprises part of a nodal piece which is inserted between adjacent leg pieces to interconnect the leg pieces.

To expand the scope of application, the legs are composed of leg pieces, and a shelf board is arranged, respectively, at the heads of three or four of the leg pieces. The heads of the respective lower leg pieces and the feet of the respective allocated upper leg pieces can be detachably connected to each other. This way, it is possible to use the shelf boards each by themselves and as separate from each other. Advantageously, the heads and feet of the leg pieces allocated to each other can be plugged into each other to establish a connection that is easily detachable; and whereby, preferably, each of the head/foot pairs of the leg pieces allocated to each other is therefore provided with a nose on the one end and with a sleeve on the other end, and one of the noses can be inserted into the sleeve creating a form closure. The fit can be improved if the leg piece and the sleeve have a conical design, in particular in such a way that any unsafe fit due to dimensional differences developing during use is precluded. It is advantageous to arrange the sleeve at the foot of the leg piece and the nose at the head of the leg piece. It is furthermore advantageous if the connection of the leg piece locks at least one of the detachable connections in place against unintentional detachment.

In one configuration the locking means act in conjunction creating a positive connection. Here, it is advantageous for the sleeve of the one end of a leg piece to be provided with a rocker key with latching nose and for the nose on the other end of a leg piece to be provided with a latching cavity or with a self-latching ball locking mechanism between sleeve and nose. In a further configuration the sleeve of the one leg piece is realized as a rotating sleeve in such a way that the latter acts in conjunction with the nose of another leg piece corresponding to it in the form of a rotating bayonet, and whereby rotating sleeve and nose are provided with recesses and protrusions corresponding to each other.

In an alternative configuration the locking means engage forming a non-positive connection, and whereby, preferably, the sleeve is slotted and provided with compression means and/or the nose is slotted and provided with expansion means, which creates the force closure that secures the connection.

Envisioned as shelf boards are non-transparent boards made of wood, metal, plastic or glass. In an alternative configuration, a transparent plastic or glass board is envisioned for use as shelf board. For applications in garden or porch areas it is advantageous if the shelf board is designed as a broken-through board.

In a preferred configuration the nose of one of the leg pieces that is inserted in the sleeve can be fastened using locking means that are envisioned between the two. In this context it is advantageous for the noses and the sleeves to have at least two slanted surfaces. This configuration produces a progressive fit with the increase in load, which is particularly advantageous for workshop tables or file frames.

In an advantageous improvement both the foot and the head of the leg piece of at least one of the legs are provided with locking means that serve to secure the easily detachable plug-in connection. This way, the leg pieces that are inserted into each other, forming an alignment that constitutes the legs, are locked as such and cannot be removed until after this lock has been released. Therefore, it is possible to lift the apparatus with shelf boards that are arranged one above the other also by gripping from the upper shelf board. Advantageously, these locking means are envisioned on at least the leg pieces of one further leg. The locking means are preferably arranged either in pairs adjacent to each other or diagonally opposite to each other. Obviously all leg pieces of any one of the legs can have locking means whereby, on the one hand, all legs can be detachably locked and, on the other hand, the shelf boards that can also be deposited as placed upside down.

The feet of the lower shelf board are provided with a plug that can be inserted into the sleeve in order to cover up said sleeve; and this plug is preferably designed at least on one of the feet of the leg pieces as a machine mount. Thus, if the floor is uneven, the apparatus can be properly aligned. In order to achieve a movable apparatus, the bottom feet of the leg pieces are equipped with swivel casters, preferably configured as trailing, that can be inserted into their sleeves.

In an advantageous improvement the nose is designed as a nodal piece that can be inserted in the leg, which is realized as a hollow profile; and the board support is arranged on the nodal piece, extending laterally, attached to or modeled in one piece as a holder for the shelf board. Nodal pieces of this type allow for an efficient manufacture of apparatuses even if the vertical distances between the shelf boards relative to each other are to be varied. It is obvious that the nodal piece may also be modeled in one piece with the corresponding leg end. The nodal piece with board support is designed as a one-piece metal die-casting piece or, in an alternative embodied example, as a one-piece plastic injection-molding piece. A matching cap is envisioned for covering up the nodal piece at the head end of the feet of the top shelf board or of a free-standing shelf board. It is also advantageous if the locking means can be inserted as insertable latching means, designed as latching insert, in the feet of the leg pieces. A safe fit is achieved by way of form closure, which is even more improved by way of the conical design of the latching insert and the foot of the leg pieces, thereby ensuring a safe, and shake-free fit. Thus, it is possible for the legs to be configured as tubes of any desired cross-section, the foot of the leg piece is formed by way of inserting the latching insert, the head of the leg piece is formed by way of inserting the nodal piece.

The board supports that are laterally attached to the nodal piece as designed as holders for a shelf board that is arranged laterally of the legs at a distance from the head of the latter. Disks are envisioned as board holders in an advantageous configuration that provides that the edge of the shelf board rests on them. To secure the supported shelf board, the disk of the board support and the supported end area of the shelf board are provided with an opening as well as a peg or projection that engages in this opening. This peg is advantageously arranged on the bottom side of the shelf board, while the disk support features the opening intended for receiving said peg. In an alternative configuration, the board support is designed as board clamps that circum-grip the edge of the shelf board. It is advantageous if the shelf board is designed in such a way that it can be removed from the board supports and used as a tray.

At least one of the shelf boards is provided with a handle element on one of its sides in order to achieve better handling properties. Advantageously, in one of the embodied examples, the lower and/or the upper of the shelf boards are/is provided with handle elements, arranged in the edge area of the board, on two sides that are opposite relative to each other, preferably the narrow sides. These handle elements make the handling of the apparatus easier because now it is less cumbersome to grip and to move; moreover, also possible is a simple lifting of the apparatus, for example, when moving it across thresholds or other uneven areas in the ground, and it is possible to lift off any upper shelf board. It is advantageous for the corresponding sides of the shelf board to be configured with recesses in order to allow for arranging the handle elements there at the edges of the board, which are configured as gripping rods that traverse this recess. In the alternative, the handle elements are designed as push-on plastic parts. On the one hand, this simplifies the assembly and, on the other hand, the handle elements can be removed again whereby the shelf board—irrespective of whether it is the lower or upper shelf board—can also be used without the handle elements. In an advantageous improvement the shelf board is designed as removable from the board supports after which step it can be used as a tray.

### BRIEF DESCRIPTION OF THE DRAWING

The objects and advantages of the invention will become apparent from the following detailed description of a preferred embodiment thereof in connection with the accompanying drawing in which like numerals designate like elements, and in which:

FIG. 1: Schematic perspective view of apparatus according to the invention with lower and upper shelf boards;

FIG. 2: Top perspective view of a leg with nose and sleeve;

FIG. 3a: Fragmentary view of positive-locking arrangement for leg parts;

FIG. 3b: Fragmentary view of non-positive locking arrangement for leg parts;

FIG. 4: Exploded perspective view of a leg;

FIG. 5: Fragmentary view of a leg broken away to reveal rocker key acting as locking means;

FIG. 6a: Longitudinal sectional view through a leg with rocker key locked;

FIG. 6b: Longitudinal sectional view through a leg with rocker key unlocked;

FIG. 7: Fragmentary perspective view showing shelf board supported on board disk;

FIG. 8: Fragmentary side view of support arm with board disk and supported shelf board;

FIG. 9: View similar to FIG. 8 of modification where the board support acts as a clamping holder for shelf board;

FIG. 10: Fragmentary view of shelf board with gripping opening;

FIG. 11: Fragmentary view of shelf board with gripping recess; and

FIG. 12: Fragmentary view of shelf board with attached gripping piece.

### DESCRIPTION OF THE PREFERRED EMBODIMENTS

FIG. 1 shows an apparatus 1, such as a cart, n and transportation of items, having two shelf boards 2. These shelf boards 2 are held in place at a distance relative to each other as well as relative to their placement surface by way of legs 4—in the representation of FIG. 1 with four legs 4. These legs are comprised of leg pieces 5 at the butt joints of which the shelf boards 2 are arranged. At the butt joint, there is located a foot 7 of an upper leg piece 5 that is arranged in alignment against a head 6 of a lower leg piece 5. Legs 4 assembled at the butt joints are provided, at least at the locations of these butt joints, with locking means that prevent any unintentional detachment of the pieces.

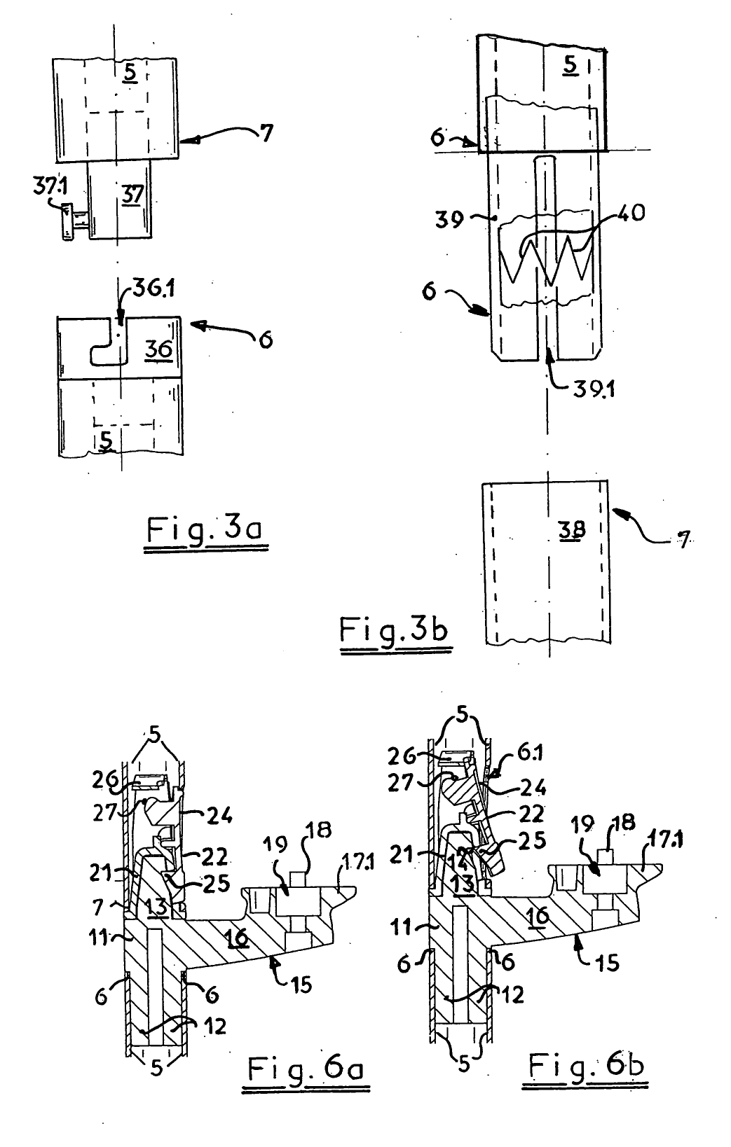

FIGS. 3a and 3b show, in an exemplary manner, alternative locking means that engage to create positive or non-positive connections, respectively. FIG. 3a depicts a rotation bayonet connection; for this purpose, head 6 of the lower foot is provided with a receiving sleeve 36 that is configured as a rotation sleeve. Foot 7 of the leg part located above the former is provided with a plug-on nose 37 including a locking pin 37.1 that extends laterally. If the locking pin is inserted into the slot 36.1 of the receiving sleeve 36 and the sleeve is rotated, this connection is positively secured against any unintentional detaching. FIG. 3b shows a connection that is secured in a non-positive fashion. The receiving sleeve 38 envisioned at head 6 of the lower foot part is designed as a smooth sleeve into which is inserted the slotted nose 39. This slotted nose is provided with a nose slot 39.1 that allows for expansion action of the slotted nose 39. An expanding spring 40 arranged in the slotted nose 39 ensures that the slotted nose 39 is being expanded and is thereby—once inserted inside the receiving sleeve 38—held in place via a frictional connection.

In the representation in FIG. 1, board supports 15 are envisioned at heads 6 of leg pieces 5 that hold shelf boards 2. For this purpose, the outer edges 2a of these shelf boards 2 are provided with recesses 3 accommodating the leg pieces 5 in order to assemble legs 4; alternatively, the aligned leg pieces 5 could project through the shelf boards.

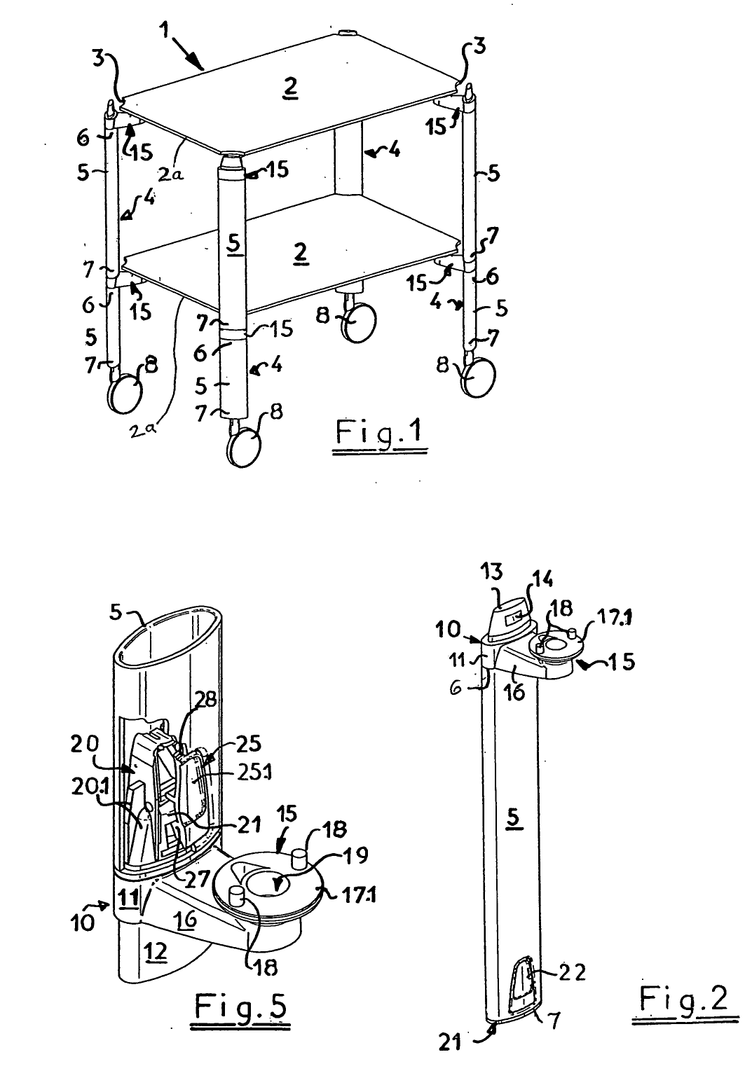

As shown in FIGS. 2-6a, locking insert 20 is inserted into the foot of a tubular leg piece 5, while upper head 6 of an opposite leg piece 5 receives nodal piece 10 that is connected to board support 15 in the form of a laterally extending arm. Nodal piece 10 is comprised of a middle piece 11 attached to which is a matching piece 12 that can be inserted into the head 6, aligned in the direction of lower leg piece 5, forming a positive connection—as is indicated by the lower short dashed lines in FIG. 4. A nose 13 of the nodal piece 10 is attached in the direction of foot 7 of the upper leg piece 5, as shown in FIG. 4 by the long dashed lines. Said nose 13 is provided with a latching cavity 14 that acts in conjunction with a latching nose of the locking inserts 20, as will be explained.

Furthermore, middle piece 11 is provided with a board support 15 comprised of support arm 16 that is attached to middle piece 11 and the free end of which is provided with a board support disk 17.1 upon which the corner area of shelf board 2 rests. Board holders that are realized as projecting pegs 18 engaging in corresponding recesses on the bottom side of shelf board 2 ensure secure positioning of this shelf board, whereby the shelf board can also have a peg on its bottom side that assumes said security function by engaging in a recess of the board support disk 17.1, e.g., a central recess 19.

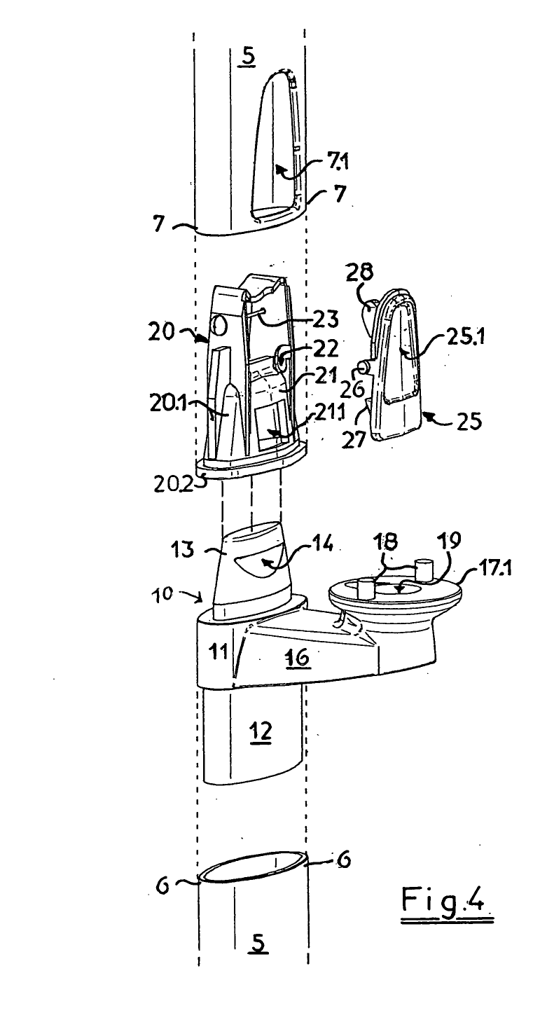

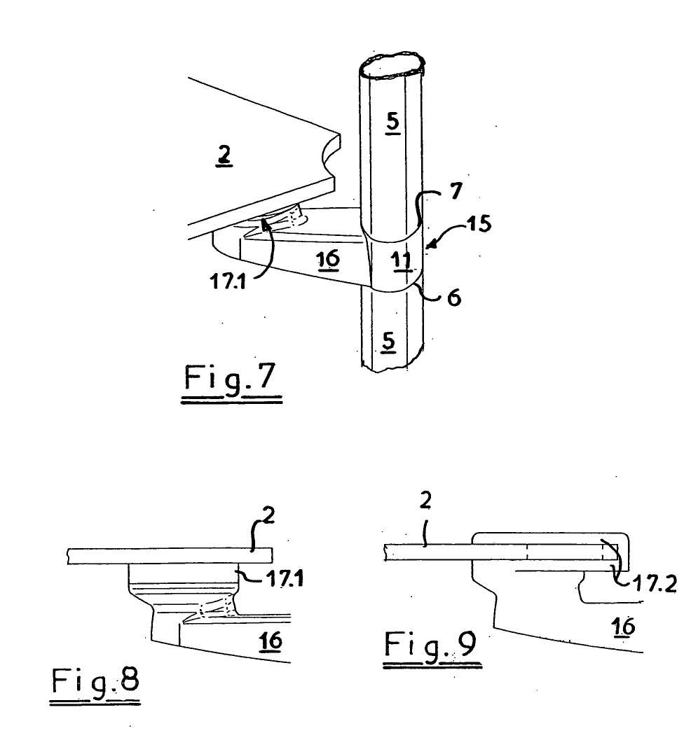

The locking means that is inserted in foot 7 of leg piece 5 includes a latching insert 20 that, as shown briefly in FIG. 4 by the upper short dashed lines, is inserted in said foot 7 and engages leg piece 5 with its end flange 20.2. This latching insert 20 is provided with a central sleeve 21 that receives nose 13 of nodal piece 10 creating a form closure, for which purpose both sleeve 21 as well as nose 13 are provided with conical surfaces that engage with each other. Latching insert 20 is provided with a rocker key 25 with lateral axial stub 26, and the rocker key is received by axis bearings 22 molded on both sides in the side walls of latching insert 20. A holding spring 23 is deflected (e.g., to the left in FIG. 6a) when the rocker key 25 is in a locked position. The spring bears against a return nose 28 of the rocker key and holds rocker key 25 in the “locked” position (FIG. 6a) and in an unlocked position (FIG. 6b). For this purpose, spring 23 acts in conjunction with a return nose 28 in such away that when rocker key 25 is activated, return nose 28 lifts spring 23 which, after gliding over the return nose 28, acts upon one of the nose's slanted surfaces, thereby securing the position of rocker key 25 in the unlocked position. It is obvious for the present context that this return position can also be configured in such a way that rocker key 25 can stay both in the “locked” position as well as in the “unlocked” position until the return action occurs.

With the locking insert 20 inserted in foot 7 of a leg piece 5, rocker key 25 extends though an opening 7.1 in the outside wall of the leg piece 5 to positively secure the locking insert to the leg piece 5. A recess 21.1 in the central sleeve 21 is provided to accommodate a locking nose 27 arranged on the back side of the rocker key 25 which can act in conjunction with the latching cavity 14 of nose 13 in such a way that locking nose 27 engages in a locked position in this latching cavity. The locking nose 27 is released from the cavity during unlocking action.

Shelf boards 2, in their varying design configurations, can be realized as smooth boards. It is also possible for shelf boards 2 to have a profiled edge 2.1. It is also possible for the edge of self boards 2 to be bent upwards in order to prevent a falling off of items deposited on shelf board 2 when the apparatus is moved around. To hold these shelf boards 2 in the area of heads 6 of leg pieces 5, they are supported in their corner areas by the board support disks 17.1. In the alternative, the corner areas could be circum-gripped by board clamping disks 17.2 (FIG. 9). In order to fix shelf board 2 in place when it rests on board support disk 17.1, pegs 18 are provided on board support disk 17.1 and engage with correspondingly configured and arranged recesses in the bottom side of shelf board 2. In the alternative, the bottom side of shelf board 2 could also be provided with a peg that engages in a recess of board support disk 17.1—represented in the present instance as central recess 19—thereby fixing the shelf board position.

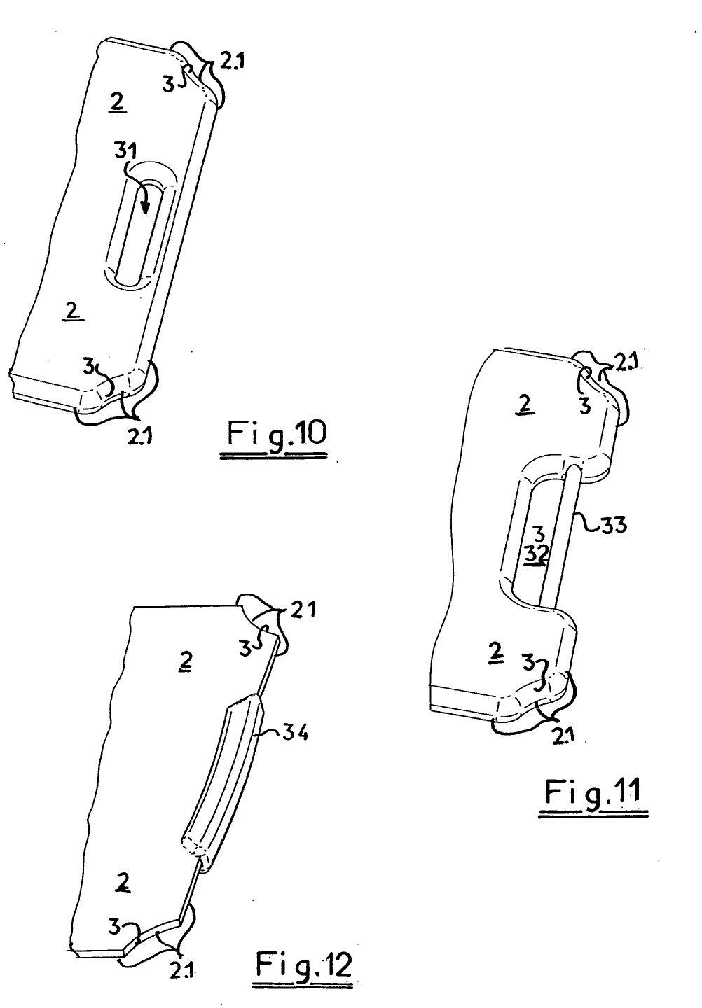

It is advantageous if shelf board 2—preferably on the two narrow sides that are opposite each other—is provided with a handle element, as shown in FIGS. 10,11 and 12. This handle can be realized as a simple gripping hole 31 that is punched out (FIG. 10), or modeled in one piece with the board or worked in any other desired manner. In the alternative, a gripping recess 32 could be provided that is closed off with a gripping rod 33 (FIG. 11). Another alternative provides for a handle element in the form of a gripping strip 34 that is attached on the edge of shelf board 2 (FIG. 12). A gripping strip 34 of this kind can be easily manufactured, for example as a plastic profile that is extrusion-molded and can be correspondingly cut to length. The gripping strip 34 made of plastic that is realized in this manner can be glued or welded to shelf board 2 in the area where the board is touched in order to counteract any undesired detachment of gripping strip 34.

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

1. Apparatus for the deposition and transportation of items, comprising:
at least three and no more than four legs, each leg comprised of a plurality of aligned leg pieces; and
a plurality of vertically spaced shelves supported by the legs, including a topmost shelf supported adjacent top ends of the legs, an outer peripheral edge of the topmost shelf including recesses for accommodating respective legs.

2. The apparatus according to claim 1 wherein the outer peripheral edges of all shelves are provided with the recesses, each leg including a plurality of vertically spaced, laterally extending support arms having a free end on which the underside of a respective shelf rests, wherein the shelf extends outwardly past the free ends such that the recesses formed in the edges of the shelves accommodate the leg pieces.

3. The apparatus according to claim 2 wherein one of the support arms comprises a portion of a nodal piece that interconnects adjacent leg pieces.

4. The apparatus according to claim 1 wherein the adjacent leg pieces of each leg are removably plugged into one another.

5. The apparatus according to claim 4 wherein a nose of one leg piece is plugged into a sleeve of the adjacent leg piece.

6. The apparatus according to claim 5 wherein the nose projects upwardly and is received in a downwardly open sleeve of the adjacent leg piece.

7. The apparatus according to claim 1 wherein the leg pieces of at least some of the legs are provided with a positive locking mechanism preventing separation of the leg pieces.

8. The apparatus according to claim 7 wherein each locking mechanism comprises a latching insert insertable into one leg piece and arranged to be latched to a nose carried by an adjacent leg piece.

9. The apparatus according to claim 8 wherein the nose comprises part of a nodal pieces insertable into the respective leg piece, the nodal pieces including a laterally extending support arm on which a shelf is supported.

10. The apparatus according to claim 9 wherein the free end of the support arm includes a shelf support disk on which the shelf sits.

11. The apparatus according to claim 10 wherein the support disk includes an opening receiving a downward projection of the shelf.

12. The apparatus according to claim 10 wherein the support disk includes an upwardly projecting peg received in an opening formed in an underside of the shelf.

13. The apparatus according to claim 10 wherein the support disk comprises a clamp in which the shelf is clamped.

14. The apparatus according to claim 7 wherein the locking mechanism comprises a bayonet coupling formed by a projection on one leg piece receivable in an L-shaped recess of an adjacent leg piece.

15. The apparatus according to claim 1 wherein the leg pieces of at least some of the legs are provided with a non-positive locking mechanism securing the leg pieces together by friction.

16. The apparatus according to claim 15 wherein an end of one leg piece is slotted to be compressed for insertion into the end of an adjacent leg piece.

17. The apparatus according to claim 1 wherein each leg includes a nodal piece inserted between adjacent leg pieces for joining the leg pieces together, the nodal piece including a laterally projecting support arm on which a respective shelf is seated.

18. The apparatus according to claim 1 wherein at least some of the legs further include a locking mechanism connected to a nodal piece for preventing separation of the nodal piece.

19. The apparatus according to claim 1 wherein the locking mechanism includes a sleeve in which a nose of the nodal piece is received, the nose including a cavity, and the sleeve carrying a pivotable rocker key releasably engageable in the cavity.

20. The apparatus according to claim 1 wherein one of the shelves is provided with at least one handle at a side of the shelf, the handle comprising a gripping hold formed in the shelf.

21. The apparatus according to claim 1 wherein one of the shelves is provided with at least one handle at a side of the shelf, the handle comprising a recess formed in an edge of the shelf, the recess being traversed by a gripping rod attached to the shelf.

22. The apparatus according to claim 1 further including a swivel caster disposed at the bottom of each leg.

23. Apparatus for the deposition and transportation of items comprising:
at least three and no more than four legs, each leg comprising a plurality of interconnected leg pieces, each leg including a plurality of vertically spaced support arms projecting laterally, each support arm including a free end, one of the support arms comprising part of a nodal piece inserted between adjacent leg pieces to interconnect the leg pieces; and
a plurality of vertically spaced shelves, each shelf having its underside seated on a plurality of the free ends of the support arms.
